(19) United States
(12) Patent Application Publication
(10) Pub. No.: US 2006/0162978 A1
(43) Pub. Date: Jul. 27, 2006

(54) Saddlebag lighting system

(75) Inventors: Lawrence David Thompson, Muskego, WI (US); David Abbe, El Cajon, CA (US)

Correspondence Address: MICHAEL BEST & FRIEDRICH, LLP, 100 E WISCONSIN AVENUE, MILWAUKEE, WI, 53202, US

(73) Assignee: Harley-Davidson Motor Company, Milwaukee, WI (US)

(21) Appl. No.: 11/156,761

(22) Filed: Jun. 20, 2005

Related U.S. Application Data
(60) Provisional application No. 60/645,631, filed on Jan. 21, 2005.

(51) Int. Cl. B62K 11/00; B62D 61/02; B62M 7/00; B62J 9/00

(52) U.S. Cl. 180/219; 224/413

(57) ABSTRACT

A motorcycle includes a frame, a front wheel, a rear wheel, a rear cargo container coupled to the frame and positioned above the rear wheel, and first and second saddlebags coupled to the frame and positioned on opposite sides of the rear wheel. The motorcycle also includes a storage lighting system including a light coupled to a the rear cargo container and positioned to direct light into one of the saddlebags.

### CROSS-REFERENCE TO RELATED APPLICATION

This application claims priority from U.S. Provisional Patent Application No. 60/645,631, entitled “Saddlebag Lighting System”, filed Jan. 21, 2005 by Lawrence David Thompson.

### BACKGROUND

The present invention relates to motorcycle storage containers, and more particularly to a storage lighting system for illuminating the inner cavities of the storage containers.

There are many types and styles of motorcycles available, including touring motorcycles. Touring motorcycles commonly include a pair of saddlebags attached to a frame of the motorcycle to provide storage. The saddlebags are typically positioned adjacent a rear portion of the motorcycle on opposite sides of the rear wheel. In addition, a touring motorcycle may include a rear storage container attached to the motorcycle frame and positioned above the rear wheel. Often, a motorcycle rider must access the storage containers at night or in a poorly lit area. Because of the size and depth of the storage containers, it can be difficult for the rider to see inside the containers or identify the rider's belongings. Therefore, a need exists for a storage lighting system to illuminate the inner cavities of the storage containers.

### SUMMARY

The present invention is directed to a saddlebag lighting system for illuminating the inner cavity of a motorcycle saddlebag. In one embodiment, the lighting system illuminates two saddlebags and includes at least two lights assemblies (e.g., having light-emitting diodes, or “LEDs”), for illuminating the inner cavities of the saddlebags. One light assembly is mounted to an exterior bottom surface of a rear storage container of the motorcycle and is positioned to direct light into a first saddlebag. Another light assembly is mounted to the exterior bottom surface of the rear storage container and is positioned to direct light into a second saddlebag. The light assemblies are turned on manually and turned off either manually or automatically after a predetermined period of time.

In one embodiment, the invention provides a motorcycle including a frame, a front wheel, a rear wheel, a rear cargo container coupled to the frame and positioned above the rear wheel, and first and second saddlebags coupled to the frame and positioned on opposite sides of the rear wheel. The motorcycle also includes a storage lighting system having a light coupled to the rear cargo container and positioned to direct light into one of the saddlebags.

In another embodiment, the invention provides a storage lighting system for a motorcycle, the storage lighting system including a first light assembly and a second light assembly. The motorcycle includes a frame, a front wheel, a rear wheel, a rear cargo container coupled to the frame and positioned above the rear wheel, and first and second saddlebags coupled to the frame and positioned on opposite sides of the rear wheel. The first light assembly is adapted to be coupled to the motorcycle frame proximate the first saddlebag and adapted to be positioned to direct light into the first saddlebag, and the second light assembly is adapted to be coupled to the motorcycle frame proximate the second saddlebag and adapted to be positioned to direct light into the second saddlebag.

In still another embodiment, the invention provides a light assembly for a motorcycle. The motorcycle includes a frame, a rear wheel, a rear cargo container coupled to the frame and positioned above the rear wheel, and first and second saddlebags coupled to the frame and positioned on opposite sides of the rear wheel. The light assembly includes an outer casing coupled to the rear cargo container, a base plate including light-emitting diodes supported by the outer casing, and a lens supported by the outer casing and positioned forward of the light-emitting diodes such that the light-emitting diodes emit light through the lens. The outer casing is positioned to direct light into one of the saddlebags.

Other aspects of the invention will become apparent by consideration of the detailed description and accompanying drawings.

### BRIEF DESCRIPTION OF THE DRAWINGS

FIG. 1 is a side view of a motorcycle embodying the present invention.

FIG. 2 is an enlarged side view of a rear portion of the motorcycle illustrating a saddlebag lighting system.

FIG. 3 is a rear view of the motorcycle illustrating a pair of saddlebags in an open position and the saddlebag lighting system

FIG. 4 is a perspective view of the saddlebag lighting system embodying the present invention.

FIG. 5 is a top view of a rear cargo container in an open position and illustrating a storage lighting system.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

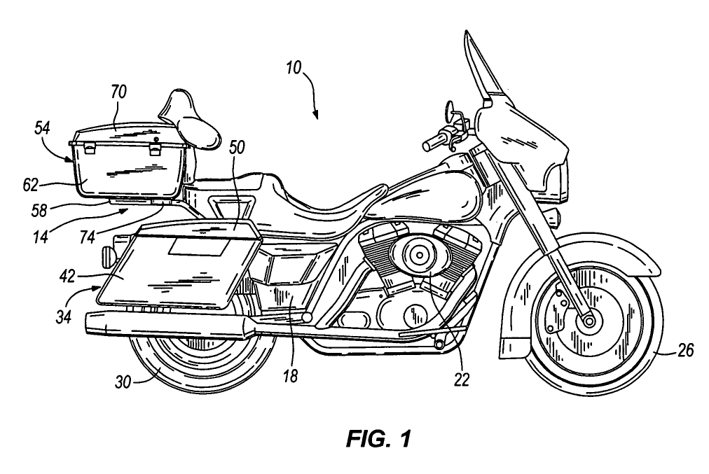

FIG. 1 is a side view of a motorcycle 10, and in particular a touring style motorcycle, having a saddlebag lighting system 14. The motorcycle 10 includes a frame 18 that supports an engine/transmission assembly 22, a front wheel 26 rotatably mounted to the frame 18, and a rear wheel 30 driven by the engine 22 and rotatably mounted to the frame 18. A pair of saddlebags 34 and 38 is attached to the frame 18 adjacent the rear wheel 30. Referring to FIG. 3, the first saddlebag 34 is located on a right side of the motorcycle 10 and the second saddlebag 38 is located on a left side of the motorcycle 10. Each saddlebag 34, 38 includes a body 42 defining an inner cavity 46 and a lid 50 hinged to the body 42 by a hinge assembly (not shown). The lid 50 is movable between a closed position (see FIG. 1) and an open position (see FIG. 3) to provide access to the inner cavity 46.

As shown in FIG. 1, the motorcycle also includes a rear cargo container 54 that is supported by a support frame 58 attached to the motorcycle frame 10. The rear cargo container 54 is positioned above the rear wheel 30. The rear cargo container 54 includes a body 62 defining an inner cavity 66 and a lid 70 hinged to the body 62 by a hinge assembly (not shown). The lid 70 is movable between a closed position (see FIG. 1) and an open position (see FIG. 3) to provide access to the inner cavity 66.

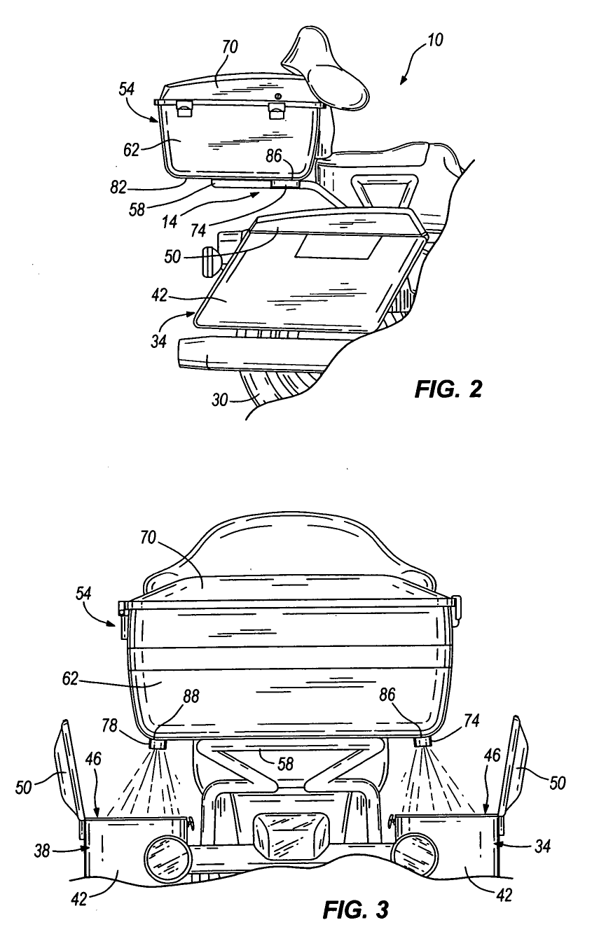

Referring to FIGS. 1, 2 and 3, the saddlebag lighting system 14 includes first and second light assemblies 74 and 78 mounted to a bottom exterior surface 82 of the rear cargo container 54. In the illustrated embodiment, the first light assembly 74 is mounted to a first bottom exterior corner 86 of the rear cargo container 54 and the second light assembly 78 is mounted to a second bottom exterior corner 88 of the rear cargo container 54. The first light assembly 74 is positioned to illuminate the inner cavity 46 of the first saddlebag 34 and the second light assembly 78 is positioned to illuminate the inner cavity 46 of the second saddlebag 38. In another embodiment, more than one light assembly is provided for illuminating the storage chamber of each saddlebag. Further, it will be recognized by those skilled in the art that the light assemblies 74, 78 of the saddlebag lighting system 14 may be mounted elsewhere on the rear cargo container 54 or on the motorcycle frame 10 as long as the light assemblies 74, 78 are positioned to direct light into the inner cavities 46 of the saddlebags 34, 38.

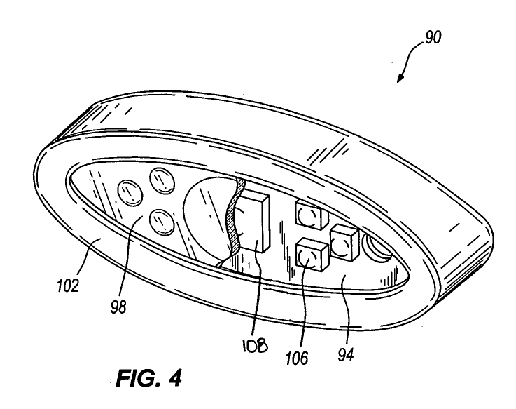

One embodiment of a saddlebag light assembly is shown in FIG. 4. The light assembly 90 includes a base plate 94, a lens 98 positioned forward of the base plate 94, and an outer casing 102 that supports the base plate 94 and the lens 98. The base plate 94 includes light-emitting diodes (LEDs) 106 on a printed circuit board (not shown) and a switch 108 to turn the LEDs on and off. Each LED 106 includes an optic (not shown) that is sized and positioned to emit light in the desired direction. Unless otherwise indicated, the term “LED” as used herein refers to both the diode element and the optic in combination. Each LED 106 emits light of a specific color. The light emitted by the LEDs 106 passes through the lens 98 to illuminate the lens 98 in the color of the LED 106. It will be recognized by those skilled in the art that a clear or translucent lens will not adversely affect the color or intensity of the light emitted. However, colored or tinted lens are contemplated and could be used with certain LEDs to achieve a desired result.

In the illustrated embodiment, the light assembly 90 has an oval shape. It will be recognized by those skilled in the art that other shapes of the light assembly are possible and any number of LEDs may be used in the assembly.

To turn the light assembly 90 on, the lens 98 of the light assembly 90 is pressed inward towards a mounting surface, which in the illustrated embodiment is defined by the bottom exterior surface 82 of the rear cargo container 54, to actuate the switch 108 and then released. To turn the light assembly 90 off, the lens 98 is pressed inward again to actuate the switch 108 and is released. Further, the light assembly 90 will automatically turn off after preset period of use (e.g., five minutes). If the lens 98 is pressed inward and held continuously, and thereby the switch 108 is held continuously, the light assembly 90 will automatically turn off after a preset period of time (e.g., 30 seconds) and disconnect itself from a power source (not shown). To reset the light assembly 90, an operator re-connects the assembly to the power source.

It should be appreciated that the light assemblies 74, 78 each could be electronically connected to a switch that is activated when opening and closing the corresponding lid 50 of the corresponding saddlebag 34, 38. In this design, the switch automatically turns the light on when the lid 50 is opened and turns the light off when the lid 50 is closed.

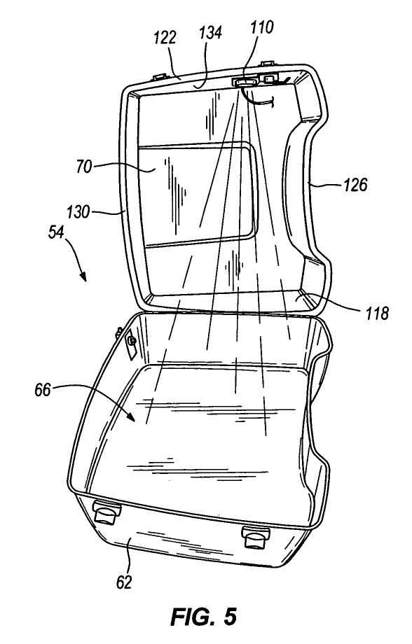

An embodiment of a storage light assembly 110 for a rear cargo container 54 is shown in FIG. 5. The light assembly 110 is mounted to an inner face of the container's lid 70 and is positioned to illuminate the inner cavity 66 of the rear cargo container 54 when the lid 70 is open. The lid 70 of the rear cargo container 54 includes four walls, a forward wall 118, a rearward wall 122 and first and second side walls 126 and 130. The light assembly 110 is mounted to an inner face 134 of the rearward wall 122 such that, when the lid 70 is in the open position (see FIG. 5), the light assembly 110 faces towards the inner cavity 66 of the rear cargo container 54. In a different embodiment, the light assembly 110 may be mounted to another inner surface of the rear cargo container 54, as long as the light assembly 110 is positioned to direct light into the inner cavity 66.

In a preferred embodiment, the light assembly 110 for the rear cargo container 54 includes a similar structure as the saddlebag light assembly 90. The light assembly 110 includes LEDs (not shown) that emit light through a lens to illuminate the inner cavity 70 of the rear cargo container 54.

To turn the storage light assembly 110 on, the lens (not shown) of the light assembly 110 is pressed inward towards the mounting surface, which in the illustrated embodiment is defined by the inner face 134 of the rearward wall 122 of the rear cargo container lid 70, and released. To turn the light assembly 110 off, the lens is pressed inward and released again, however, the light assembly 110 will automatically turn off after preset period of time (e.g., five minutes). If the lens is pressed inward and held continuously (e.g., if the lens is pressed against an item in the closed rear cargo container), the light assembly 110 will automatically turn off after a preset period of time (e.g., 30 seconds) and disconnect itself from the power source (not shown). To reset the light assembly 110, an operator re-connects the assembly to the power source. It should be appreciated that the light assembly 110 could be electronically connected to a switch that is activated when opening and closing the lid 70 of the rear cargo container 54. In this design, the switch automatically turns the light on when the lid 70 is opened and turns the light off when the lid 70 is closed.

In another embodiment of the saddlebag lighting system, a storage light assembly for the rear cargo container is included. The storage light assembly is electrically connected to a power source. The saddlebag lighting system is electrically connected to the storage light assembly such that the storage light assembly provides power to the saddlebag lighting system. Further, electronic portions of the lighting system, such as a timer mechanism, are part of the storage light assembly and are generally positioned at a mounting assembly of the storage light assembly.

The constructions and aspects described above and illustrated in the drawings are presented by way of example only and are not intended as a limitation upon the concepts and principles of the present invention. As such, it will be appreciated by one having ordinary skill in the art, that various changes in the elements and their configuration and arrangement are possible without departing from the spirit and scope of the present invention as set forth in the description above, the drawings and the following claims.

What is claimed is:

1. A motorcycle comprising:
a frame;
a front wheel and a rear wheel;
a rear cargo container coupled to the frame and positioned above the rear wheel;
first and second saddlebags coupled to the frame and positioned on opposite sides of the rear wheel; and
a storage lighting system comprising a light coupled to the rear cargo container and positioned to direct light into one of the saddlebags.

2. The motorcycle of claim 1 wherein the storage lighting system further comprises a second light coupled to the rear cargo container and positioned to direct light into the other of the saddlebags.

3. The motorcycle of claim 1 wherein the light comprises a light-emitting diode to emit light.

4. The motorcycle of claim 3 wherein light further comprises:
an outer casing coupled to the rear cargo container;
a base plate supported by the outer casing and supporting the light-emitting diode; and
a lens supported by the outer casing and positioned forward of the light-emitting diode such that the light-emitting diode emits light through the lens.

5. The motorcycle of claim 1 wherein the light includes a power mechanism for manually activating and de-activating the light.

6. The motorcycle of claim 1 wherein the light is automatically de-activated after a preset period of use.

7. The motorcycle of claim 1 wherein each saddlebag includes a lid movable between an closed position and an open position, and further wherein the light includes a switch mechanism to activate and de-activate the light when the saddlebag lid is opened and closed.

8. The motorcycle of claim 1 wherein the light is coupled to a bottom exterior surface of the rear cargo container.

9. The motorcycle of claim 1, and further comprising a second storage lighting system mounted within the rear cargo container and positioned to direct light into the rear cargo container, wherein the storage lighting system is electrically coupled to the second storage lighting system such that the second storage lighting system provides power to the storage lighting system.

10. A storage lighting system for a motorcycle, the motorcycle including a frame, a front wheel, a rear wheel, a rear cargo container coupled to the frame and positioned above the rear wheel, and first and second saddlebags coupled to the frame and positioned on opposite sides of the rear wheel, the storage lighting system comprising:
a first light assembly adapted to be coupled to the motorcycle frame proximate the first saddlebag and adapted to be positioned to direct light into the first saddlebag; and
a second light assembly adapted to be coupled to the motorcycle frame proximate the second saddlebag and adapted to be positioned to direct light into the second saddlebag.

11. The storage lighting system of claim 10 wherein each light assembly comprises a light-emitting diode to emit light.

12. The storage lighting system of claim 11 wherein each light assembly further comprises:
an outer casing;
a base plate supported by the outer casing and supporting the light-emitting diode; and
a lens supported by the outer casing and positioned forward of the light-emitting diode such that the light-emitting diode emits light through the lens.

13. The storage lighting system of claim 10 wherein each light assembly includes a power mechanism for manually activating and de-activating the light assembly.

14. The storage lighting system of claim 10 wherein each light assembly is automatically de-activated after a preset period of use.

15. The storage light assembly of claim 10 wherein each light assembly includes a switch mechanism to activate and de-activate the light assembly when the respective saddlebag is opened and closed.

16. The storage light assembly of claim 10 wherein the first light assembly is adapted to be coupled to a bottom exterior surface of the rear cargo container.

17. The storage light assembly of claim 10 wherein the second light assembly is adapted to be coupled to a bottom exterior surface of the rear cargo container.

18. The storage light assembly of claim 10, and further comprising a third light assembly adapted to be mounted to the rear cargo container and adapted to be positioned to direct light into the rear cargo container, wherein the first and second light assemblies are electrically coupled to the third light assembly such that the third light assembly provides power to the first and second light assemblies.

19. A light assembly for a motorcycle, the motorcycle including a frame, a rear wheel, a rear cargo container coupled to the frame and positioned above the rear wheel, and first and second saddlebags coupled to the frame and positioned on opposite sides of the rear wheel, the light assembly comprising:
an outer casing coupled to the rear cargo container;
a base plate supported by the outer casing, the base plate including light-emitting diodes; and
a lens supported by the outer casing and positioned forward of the light-emitting diodes such that the light-emitting diodes emit light through the lens,
wherein the outer casing is positioned to direct light into one of the saddlebags.

20. The light assembly of claim 19 wherein the lens is adapted to turn on the light-emitting diodes when the lens is pressed and released.

21. The light assembly of claim 20 wherein the lens is adapted to turn off the light-emitting diodes when the lens is pressed and released.

22. The light assembly of claim 19 wherein the light-emitting diodes turn off after a pre-set period of use.

23. The light assembly of claim 19, and further comprising a switch mechanism to activate and de-activate the light-emitting diodes when the saddlebag is opened and closed.

24. The light assembly of claim 19 wherein the outer casing is coupled to a bottom exterior surface of the rear cargo container.
